(19) United States
(12) Patent Application Publication
(10) Pub. No.: US 2005/0171736 A1
(43) Pub. Date: Aug. 4, 2005

(54) Health monitoring and diagnostic/prognostic system for an ORC plant

(75) Inventor: Pengju Kang, Hartford, CT (US)

Correspondence Address: WALL MARJAMA & BILINSKI, 101 SOUTH SALINA STREET, SUITE 400, SYRACUSE, NY, 13202, US

(73) Assignee: United Technologies Corporation

(21) Appl. No.: 10/770,155

(22) Filed: Feb. 2, 2004

(51) Int. Cl. G06F 19/00

(52) U.S. Cl. 702/185; 702/56

(57) ABSTRACT

An organic rankine cycle turbine generator includes one or more embedded sensor devices that incorporate both a 3-axis accelerometer and a digital signal processing board. The device monitors, processes, analyses and stores vibrational data to determine whether and when the defect occurs in a turbine or generator component so that appropriate action may be taken. Prognostic analysis is also performed to determine the life of a faulty component.

### BACKGROUND OF THE INVENTION

This invention relates generally to turbine generators and, more particularly, to a diagnostic system for monitoring and analyzing vibrational data of an on-line turbine generator for purposes of detecting faults in components thereof.

Professional condition monitoring engineers often use an off-the-shelf portable vibration analysis instrument to carry out the diagnosis of the condition of large rotating machines by observing the features in the vibrational spectra. The commonly practiced methodology is, as a first step, to order the normalized spectra with a fixed shaft rotating speed. Then the amplitudes of the major characteristics frequency are extracted from the spectra. After that, a fault is identified from the patterns for defects, and finally the severity of the defects is determined on the existing basis of the fault patterns. The remaining life is determined when a trend has developed.

In the manufacture of chiller compressors for use in air conditioning systems, vibration monitoring has been employed as a quality control tool to identify the abnormal vibrations caused by shaft imbalance and other types of defects before a compressor is installed into a chiller system. Such a process has been an important tool for detecting rotor and impeller imbalances in newly manufactured compressors. Further, off the shelf vibration monitoring systems have been used for fault diagnosis on large capacity chillers which have developed problems in the field.

To date, there has been no vibrational monitoring systems for continuously monitoring a compressor or turbine, on a on-line basis, while operating in its normal environment. A technique that is commonly used is that of sensing various operational temperatures and pressures that would indicate that a problem exists. For example, a damaged bearing would likely increase the temperature of the bearing, which can be sensed directly, but this would also lead to higher temperatures in the oil, which would also indicate a bearing failure. Similarly, a damaged impeller such as by loss of blades or cracked blades, would result in increased exit temperatures from the turbine, such as 205° F. versus a usual exit temperature of 190° F.

One reason that vibrational techniques have not been used for on-line monitoring and detection of faults in rotational components is that the traditional techniques for analysis have not been particularly adaptable to the variation in speeds and loads that occur in systems that are operating in their normal environment. The inaccuracies that would result from the use of off-the-shelf techniques under these varying load and speed conditions would thus render them inaccurate and misleading.

### SUMMARY OF THE INVENTION

Briefly, in accordance with one aspect of the invention, a turbine generator is provided with one or more sensors for sensing vibrations thereof on an on-line basis. A signal processor, which is embedded in the sensor and which has threshold values stored therein, processes the vibrational signals and compares the results with the stored threshold values to determine whether a fault exists. The stored data also provides for appropriate action, such as shut down, to be taken when a fault has been diagnosed.

In accordance with another aspect of the invention, the signal processor includes a filter for eliminating relevant portions of the vibrational signals, and also algorithms for applying a wavelet transform to the filtered signals to obtain representative wavelet coefficients.

By yet another aspect of the invention, the signal processor includes means for calculating the probability density function of the wavelet coefficients that have been calculated.

By still another aspect of the invention, the filtering of the vibrational signals is specific to the various components, with the vibrational signals from the bearings being passed through a low-pass filter, those from a gear being filtered by a notch filter, and those for the impeller being filtered by a band-pass filter.

By still another aspect of the invention, once a fault has been detected, the embedded prognostical software is applied to compare spectral changes to estimate the remaining life of the defective component.

In the drawings as hereinafter described, a preferred embodiment is depicted; however various other modifications and alternate constructions can be made thereto without departing from the true spirit and scope of the invention.

### BRIEF DESCRIPTION OF THE DRAWINGS

FIG. 1 is a schematic illustration of an organic rankine cycle system in accordance with a preferred embodiment of the invention.

FIG. 2 is a turbine/generator as used in an organic rankine cycle system of the present invention.

FIG. 3 is a schematic illustration of an ORC diagnostic system in accordance with the present invention.

FIG. 4 is a simplified flow chart thereof.

FIG. 5 is a graphic illustration of the vibration spectrum of various components thereof.

FIG. 6 is a zoomed verison thereof showing the effect of speed changes.

FIG. 7 is a zoomed verison of the high frequency components thereof as a function of speed.

FIG. 8 is a graphic illustration of the vibrational spectra signature of a good bearing on an ORC machine.

FIG. 9 is a normal probability plot of the wavelet transfer coefficient thereof.

FIG. 10 is a graphic illustration of a vibrational signature of a bearing with localized defects.

FIG. 11 is a normal probability plot of the wavelet transfer coefficient thereof.

FIG. 12 is a graphic illustration of the wavelet transform thereof.

FIG. 13 is a graphic illustration of the vibrational data for a healthy gear.

FIG. 14 is a normal probability plot of a healthy gear.

FIG. 15 is a vibrational signal of a defective gear.

FIG. 16 is a normal probability plot of a defective gear.

FIG. 17 is a graphic illustration of a prognostic plot.

### DESCRIPTION OF PREFERRED EMBODIMENT

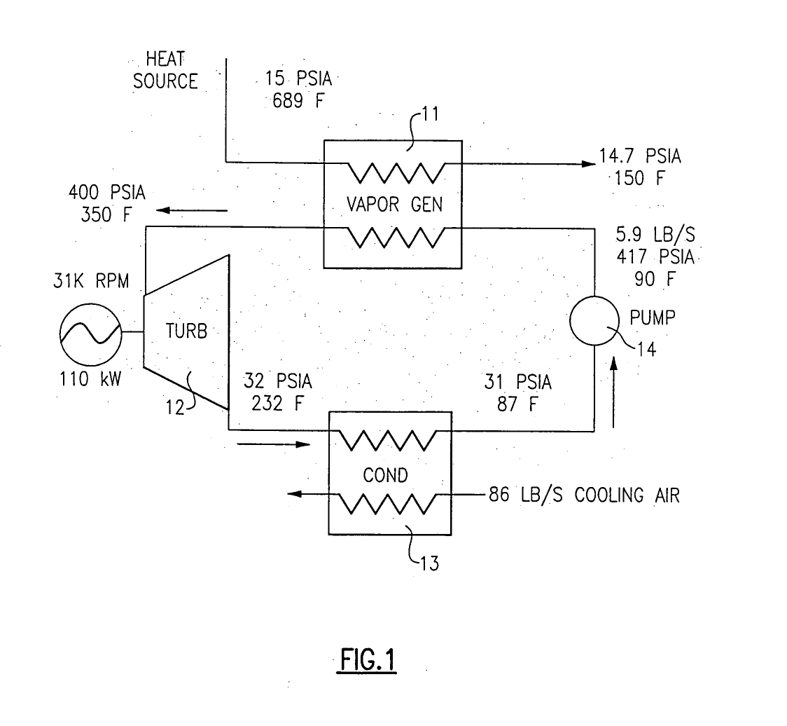

Referring now to FIG. 1, there is shown a schematic illustration of an organic Rankine bottoming cycle (ORC) which may be added to a distributed generation system to increase its overall efficiency. The ORC does not consume fuel directly, but uses the waste heat of the “prime mover”, which may be a microturbine or reciprocating device or other heat source. The primary components of such a ORC system include an evaporator or vapor generator 11, a turbine generator 12, a condenser 13 and a refrigerant pump 14. With the use of R245fa as the working fluid, the resulting pressures and temperatures of the refrigerant as it passes through the system are indicated at the particular locations shown in FIG. 1.

While the vapor generator 11, the condenser 13 and refrigerant pump 14 are rather simple and conventional components, the turbine generator 12 is more complex and subject to failure in certain components as will be described hereinafter.

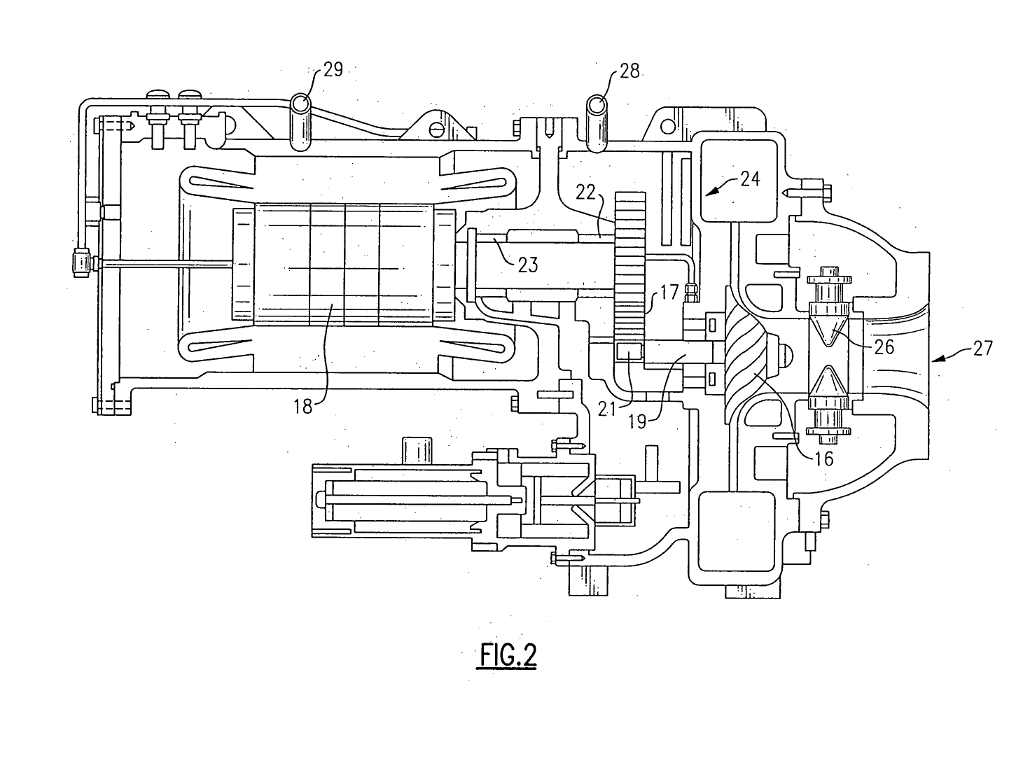

As described in some detail in U.S. patent application Ser. No. 10/293,727 filed on Nov. 13, 2002, entitled Organic Rankine Cycle Waste Heat Applications and assigned to Carrier Corporation, a wholly owned corporation owned by United Technologies Corporation, the parent of the assignee of the present invention, a motor driven compressor is used in reverse as a turbine generator in an organic Rankine cycle system. Such a turbine generator is shown in FIG. 2 and includes an impeller 16 which is drivingly connected by gears 17 to a generator 18. The impeller 16 is supported by a forward pinion and thrust bearing 19 and a rear pinion bearing 21, while the overhung generator 18 is supported by a forward generator bearing 22 and a rear generator bearing 23.

In operation, the turbine generator operates as a radial inflow turbine and receives high pressure, high temperature fluid into its inlet plenum 24. The fluid passes radially inwardly through the nozzles to strike the impeller 16 to thereby impart rotational movement thereto. The impeller then acts through the gear 17 to drive the generator 18 for generating power. After passing through the impeller 16, low pressure gas passes through the inlet guide vanes 26 to an exit opening 27. In operation, the inlet guide vanes 26 are preferably moved to the fully opened position or alternatively, entirely removed from the apparatus.

The most likely faults that occur in such an ORC turbine generator are those in the impeller 16 and the various bearings as described hereinabove. The most common types of failures are the following: 1) out of balance and looseness, 2) misalignment, bent shaft, 3) damaged bearing, 4) damaged or worn gear, 5) damaged impeller, loss of blades and cracked blades. In this regard, the applicants have recognized that the vibrational characteristics of the various components will change as a result of the above described problems to the various components. In accordance with one aspect of the invention, the vibrations present in the turbine generator during operation are monitored and analyzed for diagnostic and prognostic purposes. The sensing of these vibrations are accomplished by a pair or sensors 28 and 29 that are attached to the casing of the gear housing and the casing of the generator, respectively, as shown in FIG. 2.

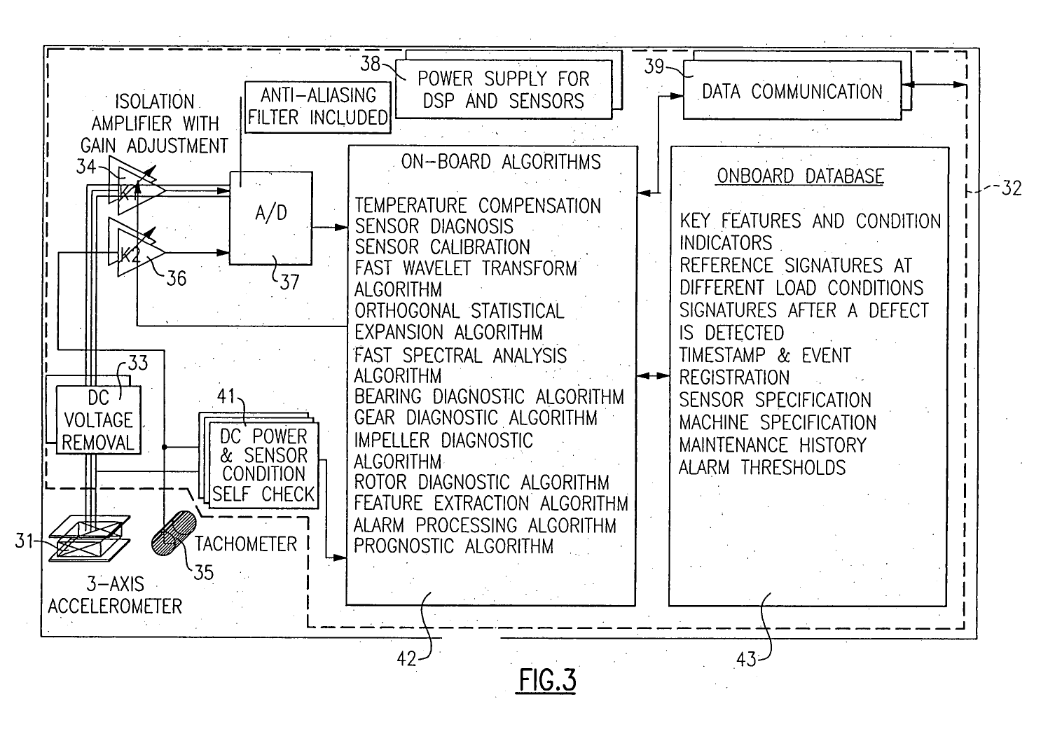

The sensors 28 and 29 are substantially identical and contain not only a 3-axis accelerometer 31 but also an embedded local digital processing (DSP) module 32 as shown in FIG. 3. The DSP module 32 is a standard microcontroller which includes a filter 33 for removal of the DC voltage, installation amplifiers with gain adjustment 34, 36 for amplification of the signals from the 3-axis accelerometer 31 and from a tachometer, if used, respectively, into an A-D convertor 37 with anti-aliasing filter included. It also includes a power supply 38 and a data communication link 39. An accelerometer failure detection function 41 may also be built into the sensor.

To program the DSP module 32 to accomplish the required tasks of incipient fault detection, a number of basic DSP algorithms shown generally at 42, as well as a database shown generally at 43, and which includes the required supporting data, are included in the DSP module 32. The details of the specific algorithms are described hereinbelow.

The 3-axis accelerometers 31 are required to have high frequency sensitivities across the entire frequency range. High resonant frequency is also required to avoid high frequency overloading. A preferred vibration sensor is a PCB type accelerometer. As shown, the 3-axis accelerometers require three channels, and they further require a sampling rate that is 3 times that of a single axis sensor.

The power supply 38 supplies power to both the accelerometers 31 and the tachometer, if used.

The output of the data communication link 39 is coded information that contains the fault condition and the remaining life of the component showing faulty conditions. The communication link can be wireless based or wired data link such as RS 232, RS 485 or CAN (Control Area Network) connection. This data is preferably communicated to an upper level controller or a centralized computer for asset management.

Although a tachometer is not required, it may be used to measure the speed of the motor which can be useful for normalizing the vibration signature and thereby eliminating the effect of load variation as it affects fault detection sensitivity. It can also be useful in the prognostic function of determining remaining life of a component.

To ensure a high level of competence in the diagnostics, the defects associated with the accelerometer 31 itself are detected on board, and minor sensor performance degradation can be corrected on board.

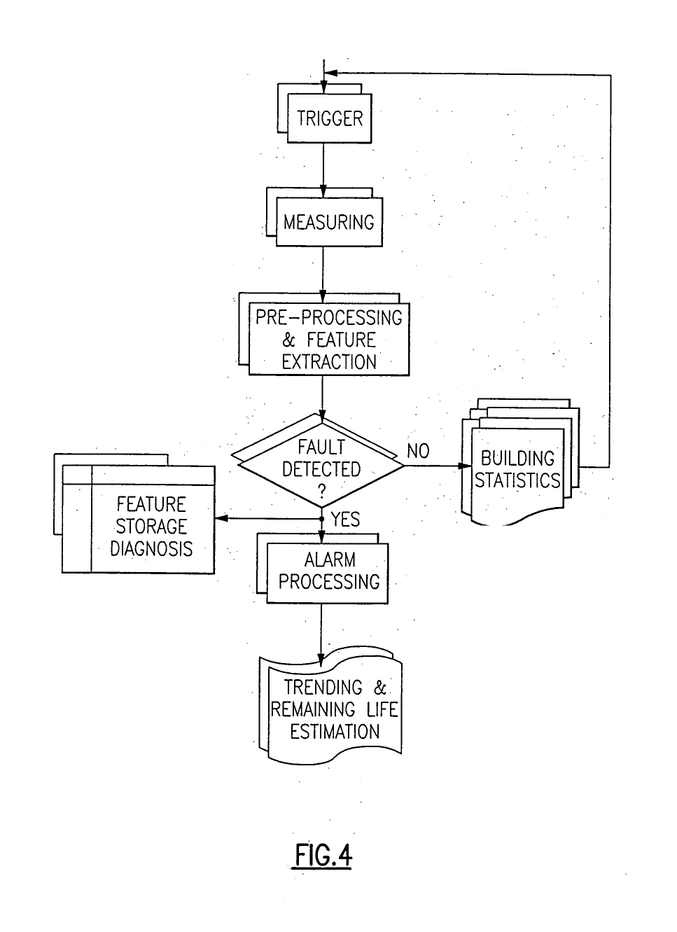

The flow chart for a diagnosis and prognosis methodology is implemented in the embedded sensors 28 and 29 as shown in FIG. 4. This methodology, which is capable of on-line, automatic, fault detection and analysis, for: 1) bearing diagnostics and prognostics, 2) gear diagnostics and prognostics, 3) impeller diagnostics and prognostics and 4) rotary imbalance diagnostics and prognostics. Each of the diagnostic/prognostic tasks follows the same process as shown in FIG. 4, with the details thereof being described hereinbelow.

An ORC turbine produces vibrations which are indicative of running condition, incipient faults and component failure. These vibrations appear at specific frequencies across a very wide spectrum. For the sake of reliable condition assessment, trustworthy measurement of low frequency pulsations, running speed and harmonics, and high frequency cavitations, requires the selected sensors to have a wide dynamic frequency range, and a signal analysis technique that is able to handle a complex spectrum.

The graphic illustrations of FIG. 5 show the major frequency components that are likely to appear in the vibration spectrum which is acquired using wide band accelerometers. The spectrum components are rotor RPM and harmonics, impeller rpm and harmonics, blade passing frequency (BPF) and gear mesh frequencies (GMF), along with the side bands.

The spectrum is displayed in log-amplitude and log-frequency scales such that both low frequency and high frequency components can be visualized on the same spectrum plot. The turbine vibration can be partitioned into four frequency ranges, namely low, medium, high, and very high frequency ranges. Low frequency monitoring is targeted at identifying fault below running speed. Oil, whirl, oil whip, and motor rub excite vibration at 40˜50% RPM vibration. Vibration of rotor speed, impeller speed and harmonics occur in mid frequency range from 60 Hz to 500 Hz. High frequency vibrations are associated with gear mesh frequencies and blade passing frequencies and possibly sidebands. They are generally in the range of 3 kHz to 6 kHz. Extremely high frequency vibrations are sometimes present in the range above 6 kHz. They appear as a broadband noise, which are caused by cavitation, vapor starvation, and bearing impact.

The rotor imbalance problems associated with misalignment can be effectively detected by the increase of ½×RPM, 133 RPM and 2×RPM components. The vibrations levels of ½×RPM, 133 RPM and 2×RPM are compared with the specified limits, and the exceedance of the limits indicates which part of the turbine is unbalanced. Generator winding damage could also be identified from monitoring the vibrations below rotation frequency. Experience has shown that amplitudes at frequencies such as ½×RPM, 133 RPM and 2×RPM are reliable in detecting turbine imbalance caused by rotor or impeller misalignments.

Operating conditions are likely to affect the amplitudes present in the turbine vibration spectrum. Variables such as speed, inlet and discharge pressure, and flow may change the spectrum profile. It has been found that it is the change of vibration trend instead of the absolute vibration levels that may be indicative of condition change, since high level vibration may be caused by load changes or support flexibility at different installation sites.

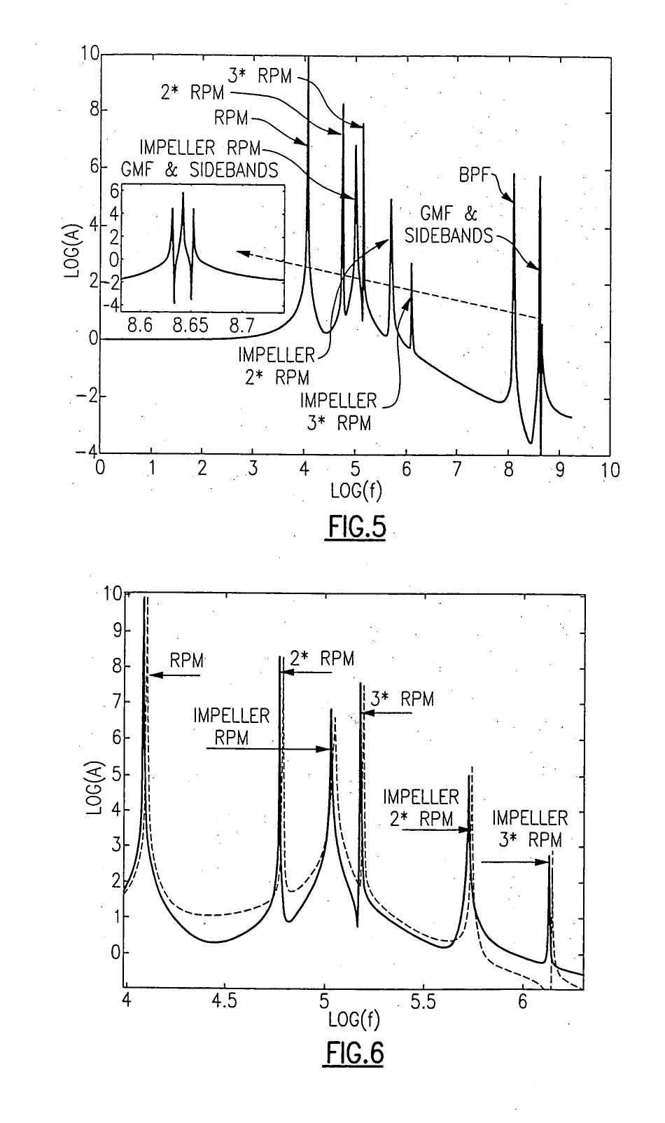

FIG. 6 illustrates the zoomed spectra showing low frequency components of the turbine-generator vibration under two different speeds. The dashed line represents the spectrum after a speed change of 1.67% of the rated speed at no load.

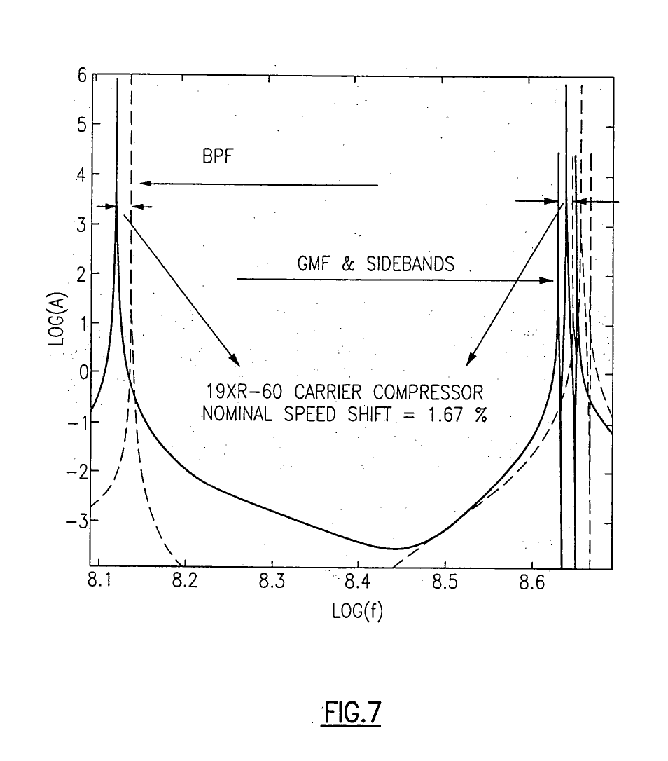

Presented in FIG. 7 is the zoomed spectra showing high frequency components of the turbine-generator vibration under two different speeds. The dashed line represents the spectrum after a speed change of 1.67% of the rated speed at no load. The typical variations in major frequencies of interest for diagnostics are listed in Table 1 below. These variations in frequency are typical for generator-turbine unit used in ORC. The data in Table 1 provide the basis for the design of diagnostic and prognostic algorithms. The diagnostic/prognostic algorithms in the present invention are adaptive in handling these frequency shifts.

TABLE 1

| | | | Impeller | | | | |
|---|---|---|---|---|---|---|---|
| RPM, | RPM, | Impeller | RPM, | BPF, | BPF, | GMF, | GMF, |
| min | max | RPM, | max | max | min | min | max |
| (Hz) | (Hz) | min (Hz) | (Hz) | (Hz) | (Hz) | (Hz) | (Hz) |
| 59 | 60 | 153.1 | 155.7 | 3367.8 | 3424.9 | 5664 | 5760 |

If the bearing is defect free, all the surfaces are smooth, and the only vibrations are the frequencies multiple to BPFO (ball pass frequency of the outer race) plus noise. Consequently the probability density function (pdf) of the bearing vibration of normal condition, excluding ball passing frequency and harmonics, should be close to Gaussian distribution. For that reason, a low pass filter with cut off frequency of 2 times of BPFO is used to clean the vibration signal before further processing. If wavelet transform (WT) (S. Mallat, Wavelet Tour of Signal Processing, Academic Press, 1998.) is applied to the filtered vibration signal, the coefficients of the wavelet transform should be close to normal distribution, since wavelet transform is a linear transformation procedure that preserves the pdf of the original signal in the wavelet domain. As a defect progresses in the bearing, a local defect generates periodic high frequency contents in the signal. The wavelet transform is very sensitive to the local changes in the signal, and, as a result, more wavelet coefficients of higher amplitude will be produced causing the pdf of the wavelet transform coefficients to deviate from a normal distribution. A benefit from using the wavelet transform is that a wavelet with moments tends to amplify the local sudden changes in the amplitude of the vibration signal, which are caused by the local defects in the bearing. The bearing detection algorithm is described as follows:

[image]

To estimate the pdf of the non-normal distribution, orthogonal statistical expansion (OSE) (A. Stuart, Kendall's Advanced Theory of Statistics, Oxford University Press, 1987) can be used. The basic idea of OSE expansion is that any pdf can be approximated by a standardized normal distribution function and residual terms:

$$pdf ( x ) = ϕ ( x ) + r ( x ) = ϕ ( x ) ( 1 + {\sum }_{i = 1}^{∞} {c}_{i} {H}_{i} ( x ) ) \qquad ( 1 )$$

where φ(x) is the standardized normal distribution function and r(x) is the residual of the expansion. Hᵢ(x) is the Hermite function of n^{th} degree, and cᵢ is the OSE coefficients, which can be calculated by:

$${c}_{i} = \frac{1}{i !} {\int }_{- ∞}^{∞} p ⅆ f ( x ) {H}_{i} ( x ) ⅆ x \qquad ( 2 )$$

If the machine is in a healthy condition, i. e. x is normally distributed, then r(x)=0. After local defects develop in the bearing, the pdf of x deviates from normal distribution, causing r(x)≠0. In practical application of OSE, often a limited number of residual terms are used. Experience shows that an 8-term expansion suffices for the application for ORC.

A detection statistic can be formulated from the OSE coefficients giving a single diagnostic index, T:

$$T = {\sum }_{i = 2}^{n} \vert {c}_{i} \vert \qquad ( 3 )$$

The following criteria is used for fault detection in bearings:

$$\begin{matrix}T = {\sum }_{i = 1}^{n} \vert {C}_{i} \vert < α \text{:} Defect free bearing \\ T = {\sum }_{i = 1}^{n} \vert {C}_{i} \vert > α \text{:} Defective bearing\end{matrix} \qquad ( 4 )$$

Where α is the predefined alarm threshold.

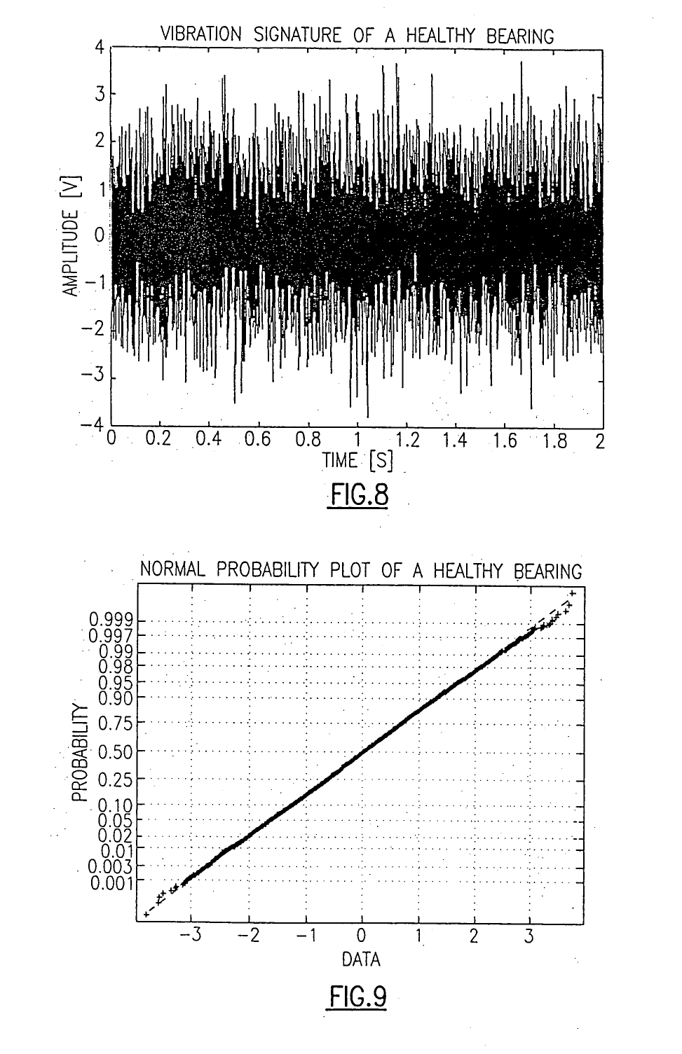

FIG. 8 shows a typical signature of a good bearing on an ORC machine. The signal has been normalized against its standard deviation (std). The normal-probability-plot of the wavelet transform coefficients of this vibration signal is shown in FIG. 9. The purpose of a normal-probability-plot is to graphically assess whether the data in a sample set could come from a normal distribution. If the data are normal, the plot will be linear. Other distribution types will introduce curvature in the plot.

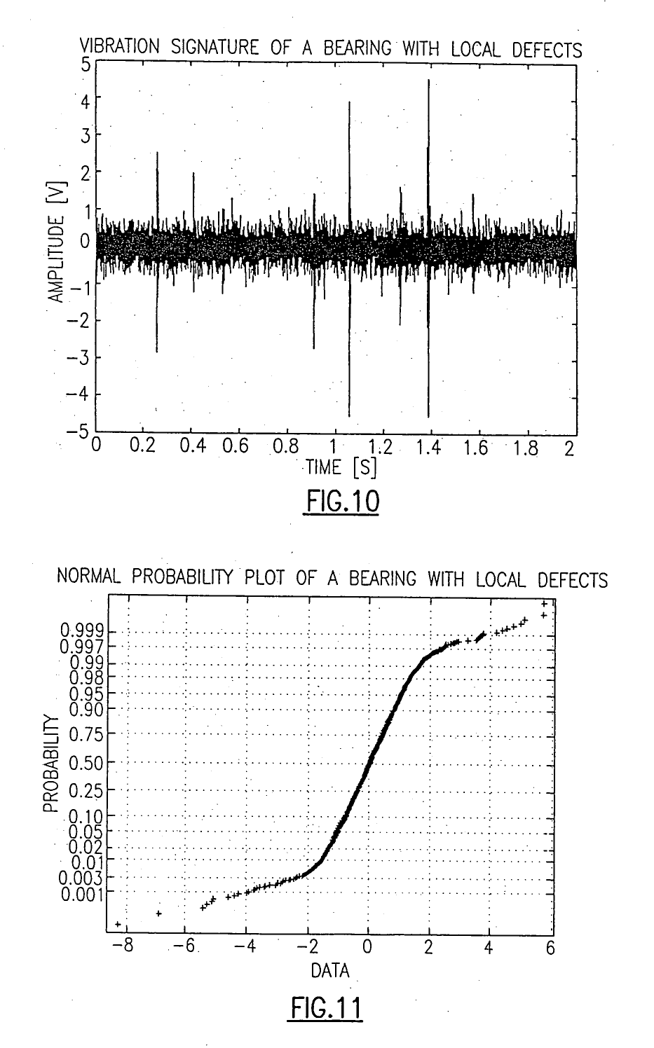

FIG. 10 shows a signature of a bearing with localized defects, which produce high frequency spikes in the vibration signal. The normal-probability-plot of the wavelet transform coefficients of this signal is shown in FIG. 11, in which a curvature occurs against the straight line indicating that the pdf of the signal is no longer Gaussian The wavelet transform of this signal is shown in FIG. 12. The transient spikes in the defective bearing vibration are typically shown in the first half of the wavelet transform.

Table 2 gives the absolute values of the OSE coefficients of the pdf of the bearing vibration signals of good and defective conditions. To illustrate the benefit of the use of wavelet transform, the OSE of the original signal and wavelet transform are compared in Table 2. From the results in this table, we can observe that the occurrences of high frequency transients cause the increase in the absolute values OSE coefficients. The amplification of the change of the pdf by the wavelet transform is also observable in that the changes of OSE coefficients using wavelet transform are more pronounced than the changes of OSE expansion coefficients of using the original signal.

TABLE 2

| | | | | | | | |
|---|---|---|---|---|---|---|---|
| \|c₂\| | \|c₃\| | \|c₄\| | \|c₅\| | \|c₆\| | \|c₇\| | \|c₈\| | Σ\|cᵢ\| |

Healthy Bearing

| | | | | | | | | |
|---|---|---|---|---|---|---|---|---|
| OSE without | 0.0000 | 0.0006 | 0.0029 | 0.0007 | 0.0005 | 0.0001 | 0.0000 | 0.0049 |
| WT | | | | | | | | |
| OSE with | 0.0000 | 0.0032 | 0.0001 | 0.0011 | 0.0003 | 0.0001 | 0.0001 | 0.0047 |
| WT | | | | | | | | |

Defective Bearing

| | | | | | | | | |
|---|---|---|---|---|---|---|---|---|
| OSE without | 0.0000 | 0.0247 | 0.1736 | 0.0556 | 0.1797 | 0.0696 | 0.1319 | 1.6352 |
| WT | | | | | | | | |
| OSE with | 0.0000 | 0.0389 | 0.3177 | 0.2267 | 0.6801 | 0.6518 | 1.0965 | 3.0119 |
| WT | | | | | | | | |

The detection algorithm of gear fault detection comes from the observation that mesh frequency and rotation frequency will appear in the spectrum of a healthy gear, but when there are local defects in the gear teeth, there will be sidebands appearing around the mesh frequency. Gear Mesh frequencies (GMF) are often very sensitive to load. High GMF amplitudes do not necessarily indicate a problem, particularly if sideband frequencies remain low and no gear natural frequencies are excited. To eliminate the effect of load changes, the original vibration signal is notch filtered, such that 133 RPM and k×GMF are removed to intensify the level of impulses caused by gear defects for the early detection of local defects on a single tooth. The vibration is notch-filtered around the mesh frequency and shaft rotation frequency producing a residual signal of normal distribution. Then the OSE expansion can be utilized on the filtered signal in the same procedure as for bearing fault detection. Once defects occur in the gear, the appearance of side bands may cause the pdf of the notch filtered vibration (residual signal) to become non-normal. This can be picked out by the OSE expansion based detection technique. The algorithm using the residue signal for gear fault detection is provided as follows:

[image]

An advantage with this technique is that it is simple to implement, and not heavily influenced by the change of speed. The defect in the gear is detected by examining the distance between the OSE of the signatures of a good gear and the OSE of the signature of later measurement:

$$D = {\sum }_{i = 2}^{8} \vert {c}_{i} - {\overline{c}}_{i} \vert \qquad ( 5 )$$

Where cᵢ is the OSE coefficients of wavelet transform coefficients of a later acquired signature, and is the OSE coefficients of the wavelet transform coefficients of the gear vibration of healthy condition. Under a healthy condition, the value of D is somewhat around zero. Any deviation beyond the value 0 will indicate the impending faults. Taking the logarithm of D should make log(D) close to normal distribution. This will allow us to set up the alarm threshold with known confidence.

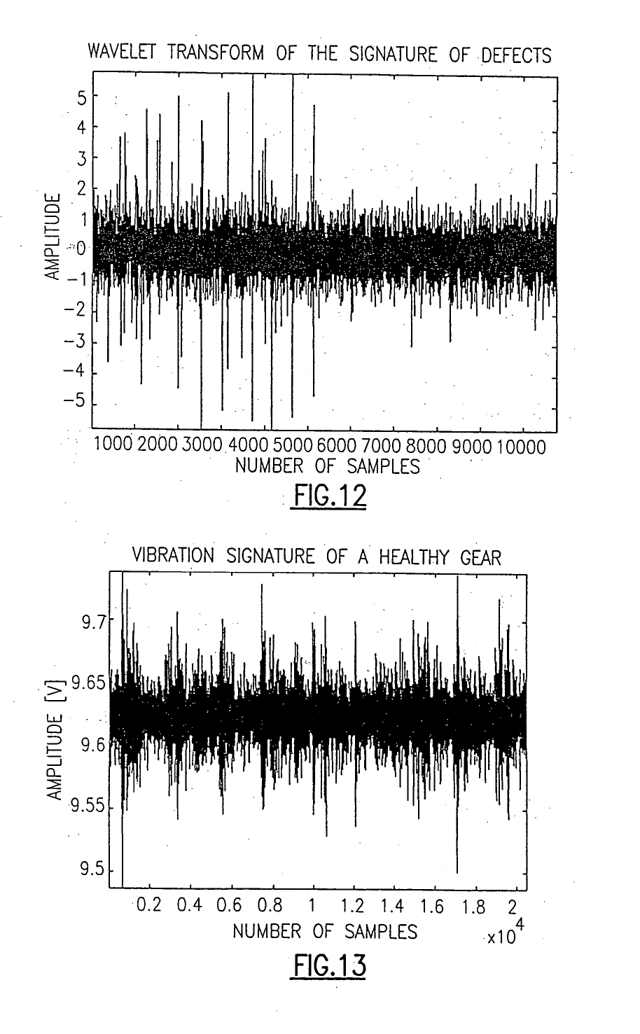

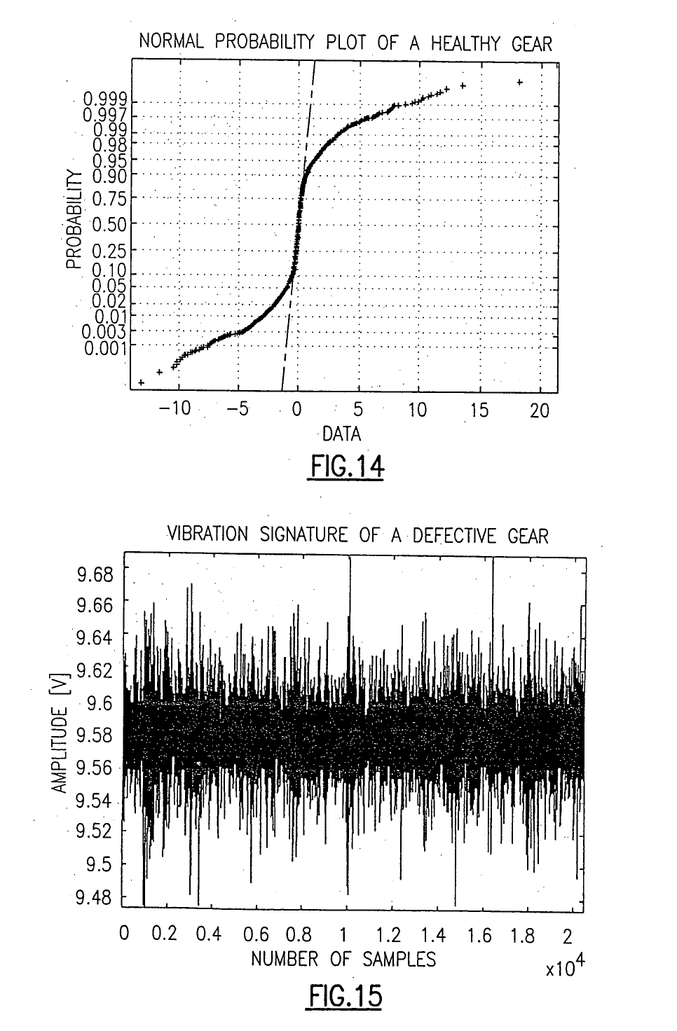

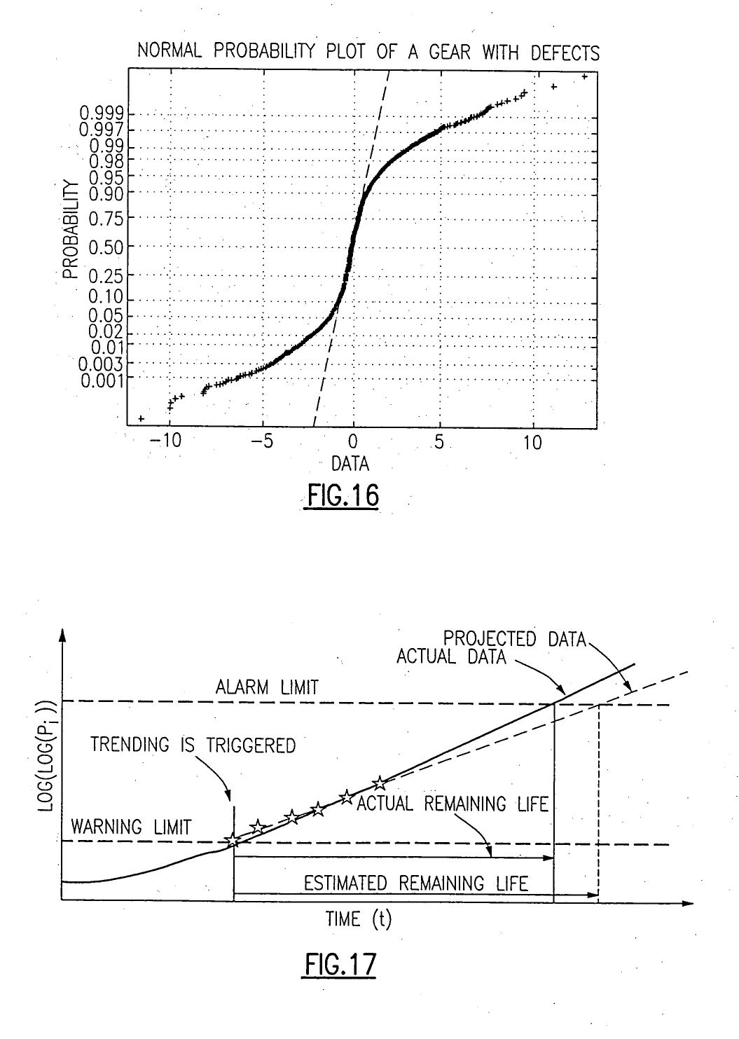

FIG. 13 shows a gear vibration, in which dominant impulses can be seen. Unlike a healthy bearing, the impulses caused by the gear meshing forces changes the pdf of the gear vibration, which is non-Gaussian as shown in FIG. 14. FIG. 15 shows the vibration signal of the gear with local defects. Due to the occurrence of additional impulses caused by the localized defects, the vibration signal is more blurred than the original signal in terms of discrimination of dominant impulses. The normal-probability-plot of the wavelet transformation of the signal is shown in FIG. 16, which shows that the pdf is still a non-Gaussian distribution after fault development. After the wavelet transformation of the two signals, OSE is applied, and the change of the gear condition becomes obvious as shown in Table 3 below, in which the total magnitude of the OSE coefficients has been decreased in a large margin from 92.7 to 4.54. This means that the pdf of a defective gear vibration approaches Gaussian. This may be explained by the fact that as defects are progressing, the impulses caused by both gear meshing and local defects are submerged into the noise floor due to the increased vibration level.

TABLE 3

| | | | | | | | |
|---|---|---|---|---|---|---|---|
| \|c₂\| | \|c₃\| | \|c₄\| | \|c₅\| | \|c₆\| | \|c₇\| | \|c₈\| | Σ\|cᵢ\| |

Healthy gear

| | | | | | | | | |
|---|---|---|---|---|---|---|---|---|
| OSE | 0.0000 | 0.1393 | 1.7566 | 2.4477 | 10.336 | 21.246 | 55.802 | 91.727 |
| coefficients | | | | | | | | |

Defective gear

| | | | | | | | | |
|---|---|---|---|---|---|---|---|---|
| OSE | 0.0000 | 0.0209 | 0.6898 | 0.0786 | 1.3110 | 0.2784 | 2.1665 | 4.545 |
| coefficients | | | | | | | | |

Field monitoring experience shows that impeller defects can be effectively detected by the increased magnitude of BPF (Ball Pass Frequency) harmonics. Under good impeller condition, 133 RPM and 233 RPM of impeller, 1×BPF (blade passing frequency), and 2×BPF and sidebands around the dominant frequencies may appear in the spectrum. This causes the pdf of the vibration signal non-normal under healthy condition. The diagnostic process is similar to gear diagnostics except for that a band pass filter is used to extract the signal content around the impeller RPM and/or BPF frequencies. After the band pass filtering, the processed signal is further processed using WT and OSE. The fault detection decision is made according to the changes in the OSE expansion coefficients, similar to the procedure used in gear diagnostics. Shown below is the algorithm for the impeller diagnostic procedure. The width of the bandpass filter is selected in such a way that possible frequency shifts caused by load variations are accounted for.

[image]

The detection procedure implemented into the embedded sensors issues an alert signal as soon as an incipient defect has been identified. Upon receiving the alert signal, the prognostic module of the device starts trending the characteristic features of the vibration signature for remaining life estimation. The procedure is carried out by searching specific feature patterns associated with the fault symptoms. By monitoring the trend of change, estimation is made on the remaining life of the defective components identified such that repair can be scheduled in advance. In the meantime, the sensor continues to monitor the change of the condition indicator of each component to check exceedance of the alarm threshold. As soon as the alarm threshold is exceeded, the machine should be shut down with minimum delay.

Traditionally a human expert observes the changes in the spectrum and manually trends the changes for prognostics. To make this process automatic is not an easy task especially when the load speed is fluctuating constantly. The present invention is able to hand the trending automatically with the use of its diagnostic/prognostics algorithms. Once the defect has been alerted, the spectrum of the vibration signature is searched for the peak magnitudes associated with the fault. The typical features searched for are presented in Table 4.

TABLE 4

| Fault Prognostics | Trending Index |
|---|---|
| Rotor imbalance or | Spectral peaks for k RPM k = 1 2 3 |
| bearing faults | |
| Oil whirl and whip | Spectral peaks for (0.4˜0.5) RPM |
| Impeller breakage | Spectral peaks for impeller RPM, |
| | and k BPF k = 1, 2 |
| Gear damage | Spectral peaks for GMF side bands |

Our test results indicate that a linear plot is generally obtained by using double logarithm transformations on the spectral peak values as listed in Table 4. A linear regression technique is used for remaining life modeling according to the following procedure:
log log(Pᵢ)=at+b (6)
Where a and b were obtained in a least square sense, Pᵢ is a peak value extracted from the spectrum corresponding to a characteristic frequency listed in Table 4.

FIG. 17 shows the degradation of the bearing condition follows the trend in which double log Pᵢ values increase in linear time scale. A straight-line fitting using a number of samples after the incipient being detected gives an accurate estimation of the remaining life. Stars in FIG. 17 represent the data points used for remaining life estimation.

While the present invention has been particularly shown and described with reference to preferred and alternate embodiments as illustrated in the drawings, it will be understood by one skilled in the art that various changes in detail may be effected therein without departing from the true spirit and scope of the invention as defined by the claims.

1. A diagnostic system for on-line monitoring and analysis of vibrational performance of a turbine generator for the purpose of determining the operational condition of its components, comprising:
at least one sensor attached to said turbine generator for sensing vibrations thereof and for generating representative vibration signals;
a signal processor for receiving said vibration signals and for generating pdf signals that are representative of their probability density functions; and
comparing means for comparing said pdf signals with predetermined values for determining whether a fault exists in the components.

2. A diagnostic system as set forth in claim 1 wherein said at least one sensor is an accelerometer.

3. A diagnostic system as set forth in claim 2 wherein said accelerometer is of the 3-axis type wherein said accelerometer is capable of simultaneously sensing vibrations in three different axes.

4. A diagnostic system as set forth in claim 2 wherein said accelerometer is of the PCB type.

5. A diagnostic system as set forth in claim 1 wherein said at least one sensor includes two sensors, with one being attached to a turbine portion of the turbine generator and one being attached to a generator portion of the turbine generator.

6. A diagnostic system as set forth in claim 1 wherein said signal processor is embedded in said sensor.

7. A diagnostic system as set forth in claim 1 wherein said signal processor also includes a filter for filtering the vibration signals.

8. A diagnostic system as set forth in claim 7 wherein the component is a bearing and further wherein said filter is a low pass filter.

9. A diagnostic system as set forth in claim 7 wherein the component is a gear and further wherein said filter is a notch filter.

10. A diagnostic system as set forth in claim 7 wherein the component is an impeller and further wherein said filter is a band pass filter.

11. A diagnostic system as set forth in claim 1 wherein said signal processor also includes means for applying a wavelet transform to the vibration signal.

12. A diagnostic system as set forth in claim 11 wherein signal processor generates said pdf signals by orthogonal statistical said expansion.

13. A diagnostic system as set forth in claim 1 and further including means for shutting down the turbine generator when a fault exists.

14. A method of monitoring an on-line turbine generator for possible faults in its rotational components comprising the steps of:
sensing the vibration of the components and generating representative vibrational signals thereof;
applying a wavelet transform (wt) to the filtered signals to obtain representative wavelet coefficients;
calculating the probability density function (pdf) of the wavelet coefficients; and
comparing said pdf with stored data to determine whether a fault exists.

15. A method as set forth in claim 14 and including an additional step of filtering said vibrational signal to eliminate non-relevant portions thereof.

16. A method as set forth in claim 14 wherein the rotational component is a bearing and further wherein said filtering process uses a low pass filter.

17. A method as set forth in claim 14 wherein the rotational component is a gear and further wherein said filtering function uses a notch filter.

18. A method as set forth in claim 14 wherein the rotational component is an impeller and further wherein said filtering step is accomplished by using a band pass filter.

19. A method as set forth in claim 14 and including a further step of modifying the operation of the turbine generator when a fault has been determined to exist.

20. A method as set forth in claim 14 and including the further step of conducting spectral analysis of a vibration signals to determine expected life of the rotational component.
